(19) United States
(12) Patent Application Publication
(10) Pub. No.: US 2007/0177839 A1
(43) Pub. Date: Aug. 2, 2007

(54) Bearing unit with brazed or soldered connection

(75) Inventors: Johannes Franciscus Van De Sanden, Nieuwegein (NL); Rene Gijsbertus Adrianus Van Breemen, Beverwijk (NL); Hendrikus Jan Kapaan, Nieuwegein (NL); Emmanuel Jacques Eyraud, San Secondo Di Penerolo (IT); Jacobus Zwarts, Nieuwegein (NL); Cornelius Petrus Antonius Vissers, Den Dungen (NL)

Correspondence Address: BUCHANAN, INGERSOLL & ROONEY PC, POST OFFICE BOX 1404, ALEXANDRIA, VA, 22313-1404, US

(73) Assignee: AB SKF, Gotegorg (SE)

(21) Appl. No.: 10/563,804

(22) PCT Filed: Jul. 8, 2004
(86) PCT No.: PCT/NL04/00492

§ 371 Date: Jul. 7, 2006

(30) Foreign Application Priority Data
Jul. 10, 2003 (NL) 1023883
Nov. 21, 2003 (NL) 1024843

(51) Int. Cl. F16C 13/00

(52) U.S. Cl. 384/589

(57) ABSTRACT

A construction unit, such as a bearing unit, comprises at least two metal means parts (9, 10; 17, 19) which are connected to each other through a connection means (11, 18, 24, 28) which comprises a brazed or a soldered connection (14, 15, 22). The connection means also comprises at least one further connection, e.g. a welded (16, 27), screwed (30), glued or a plastically formed (23) connection.

The invention is related to a bearing unit, comprising at least two bearing means which are displaceably supported with respect to each other, at least one of which bearing means comprises two metal means parts which are connected to each other through a connection means.

Such bearing units are generally known e.g. from US-A-4419816. The bearing means with the two metal means parts, e.g. the ring halves of one of the rings of a rotating element bearing, are connected to each other in a specific manner so as to establish a preload or a preplay in the bearing. According to the prior art publications, the ring halves in question are welded to each other, e.g. through laser welding.

Said prior art bearing units which are welded together exhibit several problems, which are caused by the fact that the welding process generates fairly high temperatures. These high temperatures lead to distortions and loss of quality.

The object of the invention is therefore to provide a bearing unit which lacks these adverse effects. That object is achieved in that the connection means comprises a brazed and/or soldered connection.

Brazing is a thermal process for the joining of materials involving molten filler material to wet the mating surfaces with or without the aid of a fluxing agent, leading to the formation of a metallurgical bond between the filler material and the respective components. In brazing the melting temperature of the filler material is above 450° C. but below the melting temperature of the components.

High Temperature Brazing (HTB) is similar to brazing with the difference that in HTE no fluxing agents are used. In High Temperature Brazing the fluxing activity (reduction/removing of surface oxides) is achieved by reducing atmospheres or vacuum. Usually High Temperature Brazing is done at temperatures above 300° C.

Soldering is as brazing but the melting temperatures of the filler materials is below 450° C.

Brazing and High Temperature Brazing can be characterized by the means of the heating techniques used. In principle these techniques include heating by flame, e.g. by gas fired burners such as oxygen/acetylene or oxygen/propane burners. Further techniques are heating by electrical power, resistance heating, radiant infrared, induction heating and arc brazing.

Also high power beam heating by means of a light beam (not laser), a laser beam as electron beam heating are feasible. Other heating techniques include salt bath heating and hot dip brazing.

Brazing/high temperature brazing can be done with one of the above heating methods, in a one by one technique such as manual flame brazing of piping if only a few parts need to be made, an oxygen/gas burner will be used.

For series and mass production, installations can be used especially adapted to the products to be made. Typical examples are:

Hot dip installations and hot salt bath brazing

Flame heating installations with feed through systems

Laser or arc heating for line of sight heating of products to be brazed one by one or line feed production, with or without protective atmosphere/vacuum

Electron beam heating in vacuum chambers.

Induction heating installations with feed through systems with or without vacuum chambers.

Processes that are more adapted to general used and which can handle different size and dimensions of products are:

Conveyor or chain belt furnaces working with gas fired heaters of electrical heating. These furnaces can work with protective, or reducing atmospheres

Batch furnaces working with reducing or protective atmosphere

Vacuum furnaces with electrical heating. Special technologies are the arc brazing processes and laser beam brazing. In some occasions these techniques are combined to hybrid brazing technologies. As in arc welding the arc, often a metal gas arc as used in MIG/MAG (GMAW) welding technologies, is used to melt tile filler material that is fed trough the nozzle. Such processes are typically “line of sight” processes.

Very complicated processed can be build when using modern (vacuum) furnaces. Such processes can incorporate the brazing and subsequent heat treatment processes such as hardening and tempering.

In principle, brazing/high temperature brazing is followed by bringing the temperature of the products to the required austenitizing temperature and after the required time the products can be removed from the vacuum chamber into the build in oil quench bath of the furnace or the vacuum furnace can be equipped with a gas quenching installation which is mostly using high pressure cooled nitrogen gas to quench the products.

Selection of the heating technique and the processes is (among others) depending on the:
materials to be joined
braze (filler) materials to be used
shape and dimensions of the product
number of parts
available techniques
economics
environmental issues.

The brazing or soldering process leads to temperatures which are relatively low in comparison to a welding process. As a result, the level of distortions in the bearing is much lower, and at the same time the quality of the bearing steel material can be maintained.

The invention can be carried out in many different ways. For instance, by providing both a brazed or soldered connection, as well as a further connection such as a welded connection, a screwed connection, a plastically formed connection or e.g. a clamp or clip ring connection it becomes possible to provide a wider range of specific bearing units. As an example, reference is made to a bearing unit comprising two series of rolling elements which are each in contact with a raceway of one of the ring means parts, wherein each ring means part is connected to an auxiliary ring part through a brazed connection, and said auxiliary ring parts are connected to each other through a welded connection.

The ring means parts can be of a steel type which is particularly fit for rolling contacts. In contrast, the auxiliary ring parts can be selected from steel types which enable a desired welding process to be carried out, e.g. a laser welding process. In this way for instance the ring means parts and the auxiliary rings together constitute the inner ring means. At the same time a specific bearing play or bearing preload can be obtained. The invention is applicable to all kinds of bearings, including rolling element bearings and plain bearings.

In a second type, the invention is related to a bearing assembly, comprising a bearing unit with at least two bearing means which are displaceably supported with respect to each other, and an auxiliary unit which is connected to at least one of said bearing means through a connection means. According to the invention, the connection means comprises a brazed or soldered connection. As an example reference is made to auxiliary elements carried out as e.g. additional supports for specific bearing unit applications, such as wheel bearing units. Also, brake drums, brake disks, vanes for cooling purposes etc. can be mounted in this way to a bearing unit.

A major advantage of the bearing units addressed before is furthermore related to ability to apply welding techniques. The application of welding techniques is usually limited to low carbon steels. In the field of bearing units however, high carbon steels are applied. A welding process performed on such high carbon steels would lead to the development of severe welding imperfections which are detrimental to the functionality of the bearing unit. Only by means of extreme precautions some of the problems associated with the welding of high carbon steels can be mitigated. Very often however such precautions cannot be applied due to handling problems and heat input.

As an example, reference is made to the following steel types. A very common bearing steel is SAE52100 or DIN100Cr6, which has 1 wt % carbon and 1.5 wt % chromium. Reference is also made to induction hardening steels such as SAE1070 and SAE1055. For applications with higher demands, special steel types have been developed such as Werkstoff number 1.3503, 1.3501, 1.3520, 1.3536, 1.3543, 1.3549, 1.3551 and 1.3553. In addition, stainless steels for bearings include AISI 440C and D. The high speed steel M50 is applied for aircraft bearings. These types of steel have in common a high carbon content as well as alloy elements which are carbide formers. the carbon in these steel types is responsible for the high hardness; the alloy elements such as Cr, Mo provide an improvement in the hardening depth. In general, welding of said steel types is not feasible.

The invention also encompasses the brazed or soldered connection of a plastically formed or formable auxiliary element to the bearing unit. For instance, such a plastically formed or formable auxiliary element can be brazed or soldered onto the ring of a rolling element bearing. Subsequently, said bearing can then be attached to e.g. a suspension member, such as a steering knuckle, by means of the plastically formed or formable element.

The auxiliary element thus connected to the bearing unit may also serve other purposes than connecting the bearing unit to its suspension. For instance, the auxiliary element may serve as an intermediate flange onto which e.g. mounting parts of a disc or drum brake are welded; also components such as sensor housings, brake adapters etc. may be connected in this way.

The invention will now be described further with reference to the embodiments shown in the drawings.

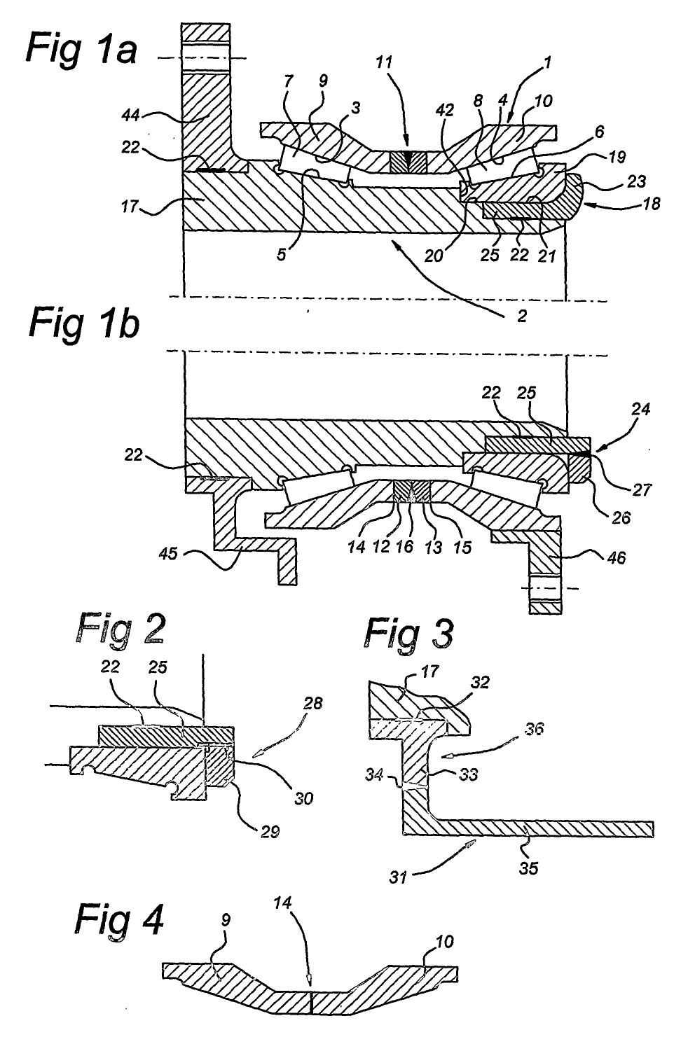

FIGS. 1a and 1b show a bearing unit according to the invention with brazed, welded respectively forged connections.

FIG. 2 shows a bearing unit with a screwed connection.

FIG. 3 shows a bearing assembly according to the invention with a brake drum connection.

FIG. 4 shows a further embodiment.

The bearing unit shown in FIGS. 1a and 1b is given as an example for illustrating specific embodiments of the invention. It is to be noted that the invention is however not limited to such kind of bearing units, but that other bearing units with different kind of rollers or of other types are also within the scope of the invention.

The bearing unit shown in FIGS. 1a and 1b has an outer bearing means 1 and an inner bearing means 2 which each comprise cone shaped raceways 3 up to 6. Between the cone shaped pair of raceways 3, 5 series of conical rolling elements 7 is accommodated, between the pair of conical raceways 4, 6 a series of conical rolling elements 8. These elements 7 respectively 8 are separated from each other by means of a cage (not shown).

The outer ring means comprises outer ring means parts 9, 10, which are mutually connected through the connecting means 11 according to the invention. The connecting means 11 comprises two intermediate ring parts 12, 13, which are each, through a respective brazed or soldered connection 14, 15 to a respective outer ring means part 9, 10. In turn, the intermediate ring parts 12, 13 are connected to each other by means of the weld 16.

Having regard to the fact that no welding operation is carried out on the ring means parts 9, 10 themselves, they can be made of a high carbon steel type which is in particular fit for rolling bearing applications. In contrast, the intermediate ring parts 12, 13 may consist of a low carbon type steel part which is particularly fit for welding purposes. The intermediate ring parts 12, 13 are themselves by means of a brazed or soldered connection 14, 15 connected to the outer ring means 9, 10, which means that a strong and stiff connection is obtained without however subjecting these high carbon outer ring means parts 9, 10 to extreme temperatures.

The inner ring means 2 comprises a carrier ring 17 which carries one of the inner conical raceways 5. The other inner conical raceway 6 is accommodated on a ring piece 19 which is slid onto the cylindrical surface 20 of the carrier ring 17 and the corresponding cylindrical surface 21 of the connection ring 18 as shown in FIG. 1a. To that end, the original shape of the connection ring 18 is fully cylindrical so as to enable the sliding action for positioning of the bearing ring 19.

Through a brazed or soldered connection 22, said connection ring 18 is connected to the carrier ring 17. Subsequently, by means of a cold forming rolling process, the bead 23 is formed. During the formation of this bead 23, the bearing ring 19 is brought into its final position, and the preload (against the abutment 42) or preplay envisaged is obtained within the bearing unit.

In FIG. 1b a connection means 24 is applied comprising a connecting sleeve 25, connected to the carrier ring 17 by means of a brazed or soldered connection 22. A radially outwardly extending ring 26 is connected to the connecting sleeve 25 by means of the weld 27. When applying the ring 26, the required preload or preplay can again be established in the bearing as in the former case.

In these embodiments as well, the brazed connections 22 allow for the selection of specific materials (high carbon/low carbon), which are particularly suitable for welding or forging the respective components. Here as well, the high carbon bearing ring 19 needs not to be welded.

The alternative of FIG. 2 is to a large extent similar to the embodiment of FIG. 1. It shows a connection means 28 consisting of a sleeve 25, onto which a ring 29 is connected by means of a screw threaded connection 30. Also this screw threaded connection can be used to obtain the required preload or preplay.

FIG. 3 shows an embodiment according to which a brake drum 31 is connected to the carrier ring 17 of FIG. 1 through the connection means 36. To that end, by means of the brazed connection 32 an auxiliary element 33 with a T-shaped cross section is connected to the carrier ring 17. Finally, by means of the weld 34, the brake drum part 35 is connected to the auxiliary element 33.

FIG. 1a shows a mounting flange 44 which is connected to the carrier ring 17 by means of a brazed or soldered connection 22. Said flange 44 may comprise a cost iron material, e.g. an ausformed ductile iron (ADI).

FIG. 1b shows a further mounting flange 45, mounted by means of a brazed or soldered connection 22 as well.

Although in FIGS. 1a, 1b and 2 the ring means parts 17, 19 are connected to each other by means of both a brazed/soldered connection and a further connection, e.g. a welded connection, it is also possible to connect said ring means parts to each other through a brazed/soldered connection only.

In the embodiment of FIG. 4, the outer ring means parts 9, 10 are directly connected to each other through a brazed or soldered connection 14.

1. Bearing unit, comprising at least two bearing means which are displaceably supported with respect to each other, at least one of which bearing means comprises two metals means parts which are connected to each other through a connection means wherein the connection means comprises a brazed and/or soldered connection.

2. Bearing unit according to claim 1, wherein the connection means also comprises at least one further connection, e.g. a welded, screwed glued or a plastically formed connection.

3. Bearing unit according to claim 1, wherein the bearing means are carried out as ring means which are rotatably supported with respect to each other, at least one of said ring means comprising ring means parts which are connected through a connection means which comprises a brazed and/or a soldered connection.

4. Bearing unit according to claim 3, wherein at least two series of rolling elements are provided which are each in contact with respective raceways of both ring means parts wherein each ring means part is connected to an intermediate ring part through a brazed connection and said intermediate ring parts are connected to each other through a welded connection.

5. Bearing unit according to claim 3, wherein at least two series of rolling elements are provided which are each in contact with respective raceways of both ring means parts, one of said ring means parts comprising an abutment and being connected to an intermediate ring part through a brazed connection, said intermediate ring part comprising a flange which is positioned at one axial end of the other ring means part, the other end of which abutting against said abutment.

6. Bearing unit according to claim 5, wherein the flange is connected to the intermediate ring part through a screw connection.

7. Bearing unit according to claim 5, wherein the flange is connected to the intermediate ring part through a welded connection.

8. Bearing unit according to claim 5, wherein the flange is obtained through plastic deformation of the intermediate ring part.

9. Bearing unit according to claim 3, wherein the ring means parts and the intermediate ring parts together constitute an inner ring means and/or an outer ring means.

10. Bearing unit according to claim 1, wherein the connection means have concentric facing surfaces which enclose a layer of brased material.

11. Bearing unit according to claim 1, wherein the bearing means are slidably supported with respect to each other.

12. Bearing unit according to claim 1, wherein the connection means comprises a relatively high grade material, e.g. a low carbon, high strength steel material, stainless steel or non-ferro materials like copper alloys, nickel alloys etc.

13. Bearing unit according to claim 1, wherein the connection means comprises a light weight material, e.g. aluminium, titanium, magnesium or their alloys.

14. Bearing unit according to claim 1, wherein at least one of the bearing means and/or the connection means comprises a ceramic component.

15. Bearing assembly, comprising a bearing unit with at least two bearing means which are displaceably supported with respect to each other, and an auxiliary unit which is connected to at least one of said bearing means through a connection means wherein the connection means comprises a brazed or soldered connection.

16. Bearing assembly according to claim 15, wherein the connection means also comprises at least one further connection, e.g. a welded, screwed, glued or plastically formed connection.

17. Bearing assembly according to claim 15, wherein the auxiliary unit comprises brake means, e.g. a brake disc or a brake drum.

18. Bearing assembly according to claim 15, wherein the auxiliary unit comprises a cooling element, e.g. a vane member.

19. Bearing assembly according to claim 15, wherein the auxiliary unit comprises a mounting flange.

20. Bearing assembly according to claim 19, wherein the mounting flange comprises a cast iron material, e.g. an ausformed ductile iron.
